(19) United States
(12) Patent Application Publication
(10) Pub. No.: US 2015/0193592 A1
(43) Pub. Date: Jul. 9, 2015

(54) METHOD AND APPARATUS FOR GROUPING PRESCRIPTIONS

(71) Applicant: McKesson Financial Holdings, Hamilton (BM)

(72) Inventors: Rodrick Orlando Adams, Pittsburgh, PA (US); Roma Roy, Pittsburgh, PA (US)

(73) Assignee: McKesson Financial Holdings, Hamilton (BM)

(21) Appl. No.: 14/148,127

(22) Filed: Jan. 6, 2014

(51) Int. Cl. G06F 19/00; G06Q 10/06

(52) U.S. Cl. CPC G06F 19/3456; G06Q 10/06316

(57) ABSTRACT

A method, apparatus, and computer program product are provided in order to group prescriptions for the same patient into a single order so as to provide for more efficient fulfillment and shipping. In the context of a method, a plurality of prescriptions are received in an electronic or facsimile format. In this regard, the method includes receiving a first prescription and thereafter receiving a second prescription. The method also includes determining if the first and second prescriptions are associated with the same patient and also determining if the first and second prescriptions are received within a predefined window of time. In an instance in which the first and second prescriptions are associated with the same patient and are received within the predefined window of time, the method includes grouping, with processing circuitry, the first and second prescription into a single order.

### TECHNOLOGICAL FIELD

An example embodiment of the present invention relates generally to the processing, fulfillment, and shipment of prescriptions and, more particularly, to the grouping of prescriptions so as to permit more efficient processing, fulfillment, and shipment of the prescriptions.

### BACKGROUND

A large number of prescriptions are written every day for a multitude of patients. These prescriptions are provided to pharmacies that process the prescriptions in order to fulfill the prescriptions. Once filled, the prescriptions may then be provided to the patients.

Multiple prescriptions may be written for the same patient at about the same time, such as the result of a visit to a physician, upon discharge from a hospital, etc. For example, a patient may be prescribed one or more antibiotics, as well as one or more medicines intended to reduce fever, reduce nausea or otherwise address symptoms experienced by the patient.

A number of pharmacies, such as many hospital outpatient pharmacies, are transitioning to the use of electronic prescriptions. In these systems, physicians may transmit electronic prescriptions to pharmacies via a secure electronic exchange. Electronic prescriptions, such as prescriptions submitted in an electronic or facsimile format, are not grouped and are, instead, submitted individually, even if multiple electronic prescriptions relate to the same patient and are generated at about the same time, such as a result of a visit to a physician, upon discharge from a hospital or the like. Thus, electronic prescriptions relating to the same patient are not grouped into a single patient order request.

Consequently, pharmacies that receive electronic prescriptions may require workers to manually group prescriptions for the same patient into a single patient order request, thereby increasing the costs associated with fulfillment of the prescriptions. Some pharmacies, such as hospital outpatient pharmacies, may rely heavily on the use of central fulfillment and mail order to service the patients' needs following discharge from the hospital. In these settings, unless workers manually group prescriptions for the same patient together into a single patient order request, the plurality of prescriptions for the same patient may be fulfilled and shipped individually, thereby increasing the shipping and manifesting fees associated with fulfillment of the prescriptions.

### BRIEF SUMMARY

A method, apparatus, and computer program product are provided in accordance with an example embodiment in order to group prescriptions for the same patient into a single order. As such, a method, apparatus, and computer program product of an example embodiment may increase the efficiency with which prescriptions are fulfilled and, in some instances, shipped. In this regard, the method, apparatus, and computer program product of an example embodiment may reduce or eliminate manual labor associated with grouping of related prescriptions into a single order. Additionally or alternatively, the method, apparatus, and computer program product of an example embodiment may reduce the costs associated with individually shipping multiple prescriptions to the same patient.

In one embodiment, a method is provided that includes receiving a plurality of prescriptions in an electronic or facsimile format. In this regard, the method includes receiving a first prescription and thereafter receiving one or more additional prescriptions, hereinafter generically referred to as a second prescription. The method also includes determining if the first and second prescriptions are associated with the same patient and also determining if the first and second prescriptions are received within a predefined window of time. In an instance in which the first and second prescriptions are associated with the same patient and are received within the predefined window of time, the method includes grouping, with processing circuitry, the first and second prescription into a single order. In an example embodiment, there may be no limit to the number of prescriptions that can be grouped into a single order for the same patient with the determinative factors as to whether prescriptions are grouped into an order being the window of time and one or more matching parameters, such as the patient identifier, e.g., the patient number, and the prescription intake method, e.g., a computerized prescription submission application or facsimile.

The method of one embodiment further includes placing the first prescription in a grouping queue following its receipt. The placing of the first prescription may start the window of time for grouping prescriptions for the same patient into an order. The method of this embodiment may determine if the first and second prescriptions are received within the predefined window of time by determining if the first prescription has been in a grouping queue for no more than a predefined grouping time limit. In this embodiment, the method may group the first and second prescriptions into a single order in an instance in which the first prescription has been in the grouping queue for no more than predefined grouping time limit upon receipt of the second prescription.

The method of an example embodiment may also include causing the first and second prescriptions that have been grouped into a single order to be shipped together. The method of an example embodiment may also include associating the same order level parameters with all prescriptions grouped into a single order. In this embodiment, the method may also include modifying an order level parameter for all prescriptions grouped into the single order in response to a change in the order level parameter for one of the prescriptions grouped into the single order. In one embodiment, the method may also include releasing one or more prescriptions that have been previously grouped into a single order such that the one or more prescriptions are advanced at a faster rate through the workflow relative to one or more other prescriptions that were also previously grouped in the single order.

In another embodiment, a computer device is provided that includes processing circuitry configured to receive a plurality of prescriptions in an electronic or facsimile format. In this regard, the processing circuitry is configured to receive a first prescription and thereafter receive a second prescription. The processing circuitry of this example embodiment is also configured to determine if the first and second prescriptions are associated with the same patient and also to determine if the first and second prescriptions are received within a predefined window of time. In an instance in which the first and second prescriptions are associated with the same patient and are received within the predefined window of time, the processing circuitry of this example embodiment is further configured to group the first and second prescriptions into a single order.

The processing circuitry of an example embodiment may be further configured to place the first prescription in a grouping queue following its receipt. The processing circuitry of this embodiment may also be configured to determine if the first and second prescriptions are received within a predefined window of time by determining if the first prescription has been in the grouping queue for no more than a predefined grouping time limit. The processing circuitry of this embodiment may also be configured to group the first and second prescriptions into a single order in an instance in which the first prescription has been in the grouping queue for no more than the predefined grouping time limit upon receipt of the second prescription.

The processing circuitry of an example embodiment may be further configured to cause the first and second prescriptions that have been grouped into a single order to be shipped together. The processing circuitry of an example embodiment may also be further configured to associate the same order level parameters with all prescriptions grouped into a single order. In this embodiment, the processing circuitry may be further configured to modify an order level parameter for all prescriptions grouped into the single order in response to a change in the order level parameter for one of the prescriptions grouped into the single order. The processing circuitry of an example embodiment may be further configured to release one or more prescriptions that have been previously grouped into a single order such that one or more prescriptions are advanced at a faster rate through the workflow relative to one or more other prescriptions that were also previously grouped into the single order.

In a further embodiment, a computer program product is provided that includes a non-transitory computer readable medium having program code stored thereon with the program code including program code instructions configured, upon execution, to receive a plurality of prescriptions in an electronic or facsimile format. In this regard, the program code instructions are configured to receive a first prescription and thereafter to receive a second prescription. The program code of this embodiment also includes the program code instructions configured to determine if the first and second prescriptions are associated with the same patient and to determine if the first and second prescription are received within a predefined window of time. In an instance in which the first and second prescriptions are associated with the same patient and are received within the predefined window of time, the program code of this embodiment also include program code instructions configured to group the first and second prescriptions into a single order.

The program code of one embodiment may also include program code instructions configured to place the first prescription in a grouping queue following its receipt. In this embodiment, the program code instructions configured to determine if the first and second prescriptions are received within a predefined window of time may include program code instructions configured to determine if the first prescription has been in the grouping queue for no more than a predefined grouping time limit. The program code instructions of this embodiment that are configured to group the first and second prescriptions into a single order may do so in an instance in which the first prescription has been in the grouping queue for no more than the predefined grouping limit upon receipt of the second prescription.

The program code of an example embodiment may also include program code instructions configured to cause the first and second prescriptions that have been grouped into a single order to be shipped together. The program code of an example embodiment may also include program code instructions configured to associate the same order level parameters with all prescriptions grouped into a single order. The program code of this embodiment may also include program code instructions configured to modify an order level parameter for all prescriptions grouped into the single order in response to a change in the order level parameter for one of the prescriptions grouped into the single order.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a system that may support the exchange of electronic prescriptions, such as prescriptions in an electronic or facsimile format;

FIG. 2 is a block diagram of a computing device that may be specifically configured in accordance with an example embodiment of the present invention in order to group prescriptions into a single order;

FIG. 3 is a flowchart illustrating the operations performed, such as by the computing device in FIG. 2, in accordance with an example embodiment of the present invention; and

FIG. 4 is a representation of a graphical user interface illustrating a grouping queue and the status of a plurality of prescriptions therein in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

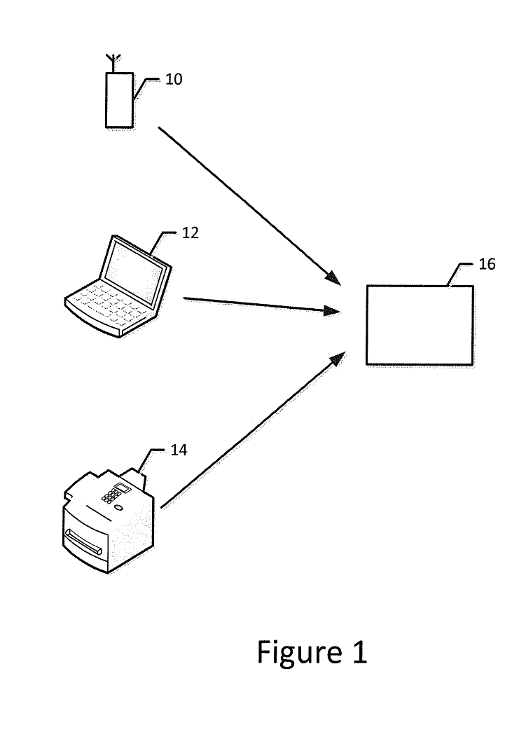

A method, apparatus, and computer program product are provided in accordance with an example embodiment in order to facilitate the grouping of electronic prescriptions. The electronic prescriptions may be written by a wide variety of physicians, nurse practitioners or other healthcare practitioners (hereinafter generically referenced as “physicians”), and transmitted to a pharmacy or other fulfillment center (hereinafter generically referenced as a “pharmacy”). As shown in FIG. 1, the prescription may be submitted in an electronic or facsimile format from any of a wide variety of devices, including a handheld mobile terminal 10, such as a smartphone, a personal digital assistant (PDA), a tablet computer, or the like, from a computer 12 such as a personal computer, a computer workstation or the like, or from a facsimile machine 14.

Regardless of the manner in which the prescriptions are submitted, the prescriptions may be transmitted to the pharmacy via a secure electronic exchange, such as may be provided by the Surescripts® E-prescriptions network. The pharmacy, upon receipt of the prescriptions, may process the prescriptions in accordance with an example embodiment of the present invention in order to group prescriptions related to the same patient that are received within a predefined time window into a single order. As such, the prescriptions that are grouped together may be fulfilled and, in some instances, shipped in a more efficient manner.

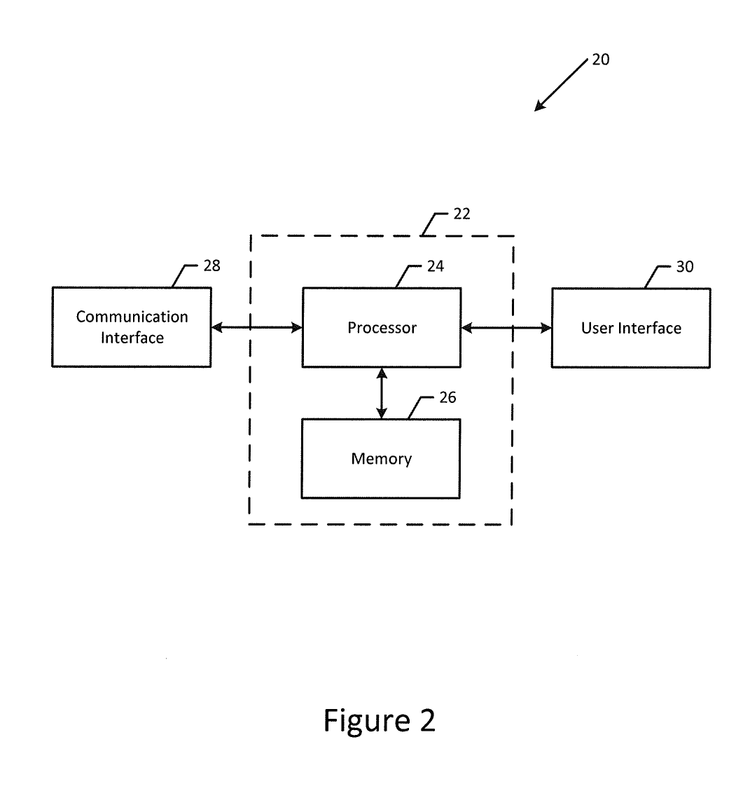

The prescriptions that are submitted via the secure electronic exchange to the pharmacy are received by a computer system 16 of or associated with the pharmacy, such as a server, a computer workstation, or the like. The computer system may include or be associated with a computing device 20, such as shown in FIG. 2, that is specifically configured to process the prescriptions in order to group related prescriptions into a single order in accordance with an example embodiment of the present invention. The computing device of FIG. 2 may be operated by the pharmacy or may be operated by a third party with whom the pharmacy has a business relationship.

As shown in FIG. 2, the computing device 20 of FIG. 2 may include or otherwise be in communication with processing circuitry 22 that is configurable to perform actions in accordance with one or more example embodiments disclosed herein. In this regard, the processing circuitry may be configured to perform and/or control performance of one or more functionalities of the computing device in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 22 may include a processor 24 and, in some embodiments, such as that illustrated in FIG. 2, may further include memory 26. The processing circuitry may be in communication with or otherwise control a communication interface 28 and, in some embodiments, a user interface 30. As such, the processing circuitry may be embodied as a circuit chip (e.g., an integrated circuit chip) configured (e.g., with hardware, software or a combination of hardware and software) to perform operations described herein.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities of the computing device 20 as described herein. The plurality of processors may be embodied on a single computing device or distributed across a plurality of computing devices collectively configured to function as the computing device. In some example embodiments, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 26 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices collectively configured to function as the computing device 20. The memory may be configured to store information, data, applications, instructions and/or the like for enabling the computing device to carry out various functions in accordance with one or more example embodiments. For example, the memory may be configured to buffer input data for processing by the processor 24. Additionally or alternatively, the memory may be configured to store instructions for execution by the processor. As yet another alternative, the memory may include one or more databases that may store a variety of files, contents or data sets, such as electronic health records for a plurality of patients. Among the contents of the memory, applications may be stored for execution by the processor in order to carry out the functionality associated with each respective application. In some cases, the memory may be in communication with one or more of the processor, user interface 30, or communication interface 28 via a bus or buses for passing information among components of the computing device.

The user interface 30 may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the computing device 20 is implemented on a server or other network device, aspects of the user interface may be limited, or the user interface may even be eliminated. For example, the computing device may act as a server or host device, with a user interface provided by a client application.

The communication interface 28 may include one or more interface mechanisms for enabling communication with other devices and/or networks, such as the various devices, e.g., mobile terminals 10, computers 12, facsimile machines 14 or the like, via which prescriptions may be presented. In some cases, the communication interface may be any means such as a device or circuitry embodied in either hardware, or a combination of hardware and software that is configured to receive and/or transmit data from/to a network and/or any other device or module in communication with the processing circuitry 22. By way of example, the communication interface may be configured to enable the computing device 20 to communicate with a server or other network device via a wireless network, such as a wireless local area network (WLAN), cellular network, and/or the like. Additionally or alternatively, the communication interface may be configured to enable the computing device to communicate with the server or other network device via a wireline network. In some example embodiments, the communication interface may be configured to enable communication between the computing device and one or more servers or other network devices via the interne. Accordingly, the communication interface may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described computing device 20 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

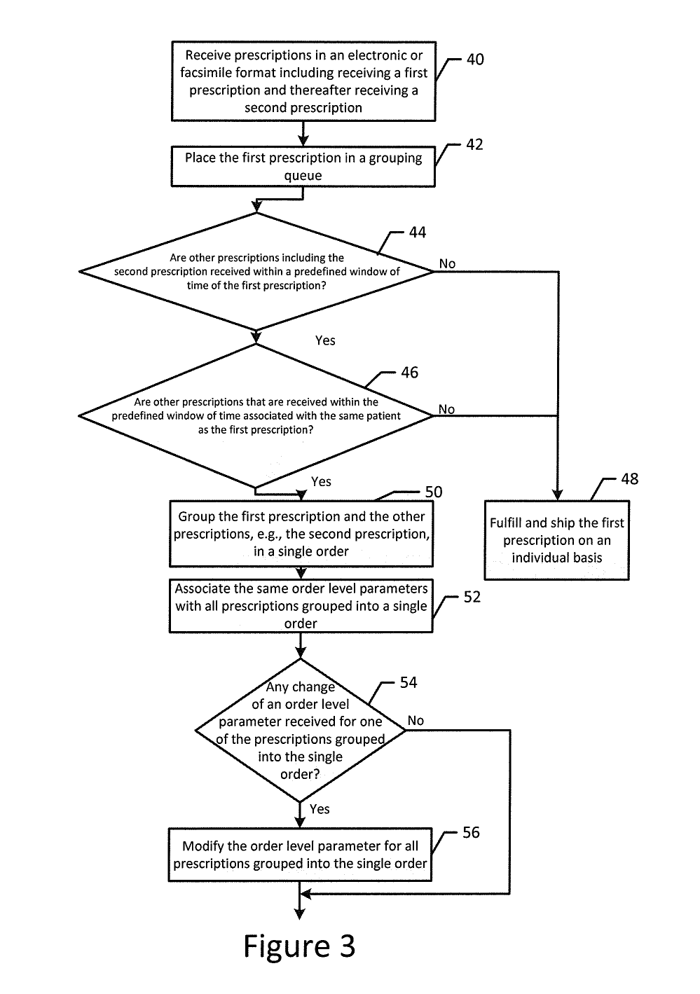

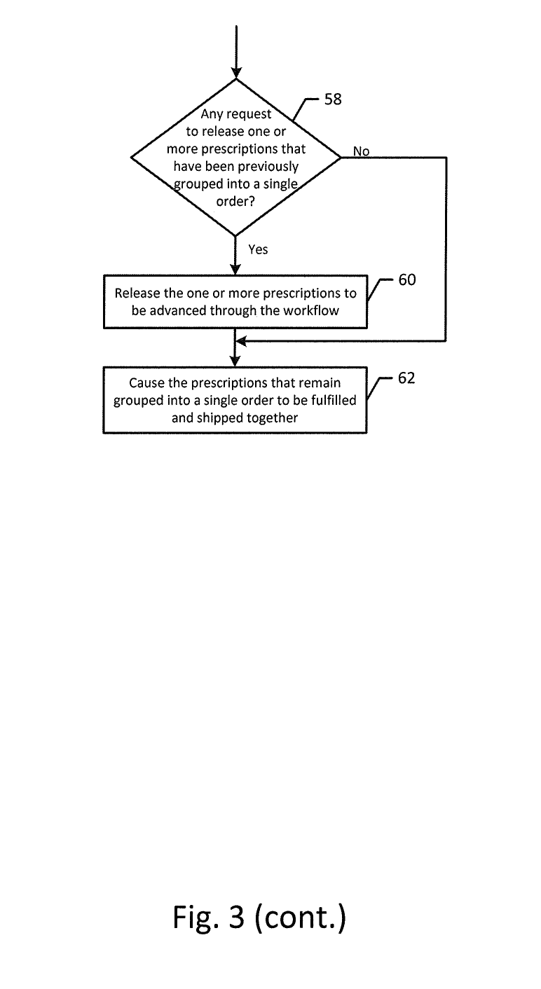

Referring now to FIG. 3, the operations performed, such as by the computing device 20, in order to group prescriptions into a single order are illustrated. As shown in block 40 of FIG. 3, the computing device, such as the processing circuitry 22, e.g., the processor 24, the communication interface 28 or the like, is configured to receive prescriptions in an electronic or facsimile format. The prescriptions may include a variety of information including information identifying the prescribing physician, the medicine being prescribed including the dosage and instructions regarding the manner in which the medicine is to be taken, information regarding refills, information identifying the patient, etc. The computing device, such as the processing circuitry, the communication interface or the like, may be configured to receive from physicians prescriptions in an electronic format, such as prescriptions transmitted from a mobile terminal 10 or a computer 12, or prescriptions transmitted in a facsimile format, such as from a facsimile machine 14. In one example, the prescriptions in the electronic or facsimile format may be received via a secure electronic exchange, such as the Surescripts® E-Prescription network.

The computing device 20, such as the processing circuitry 22, the communication interface 28 or the like, may be configured to receive a plurality of prescriptions in an electronic or facsimile format at different points in time. For example, the computing device, such as the processing circuitry, the communication interface or the like, may be configured to receive a first prescription and to thereafter receive a second prescription. The first and second prescriptions may relate to the same patient or to different patients. Additionally, the first and second prescriptions may be received very close in time to one another or widely separated in time from one another.

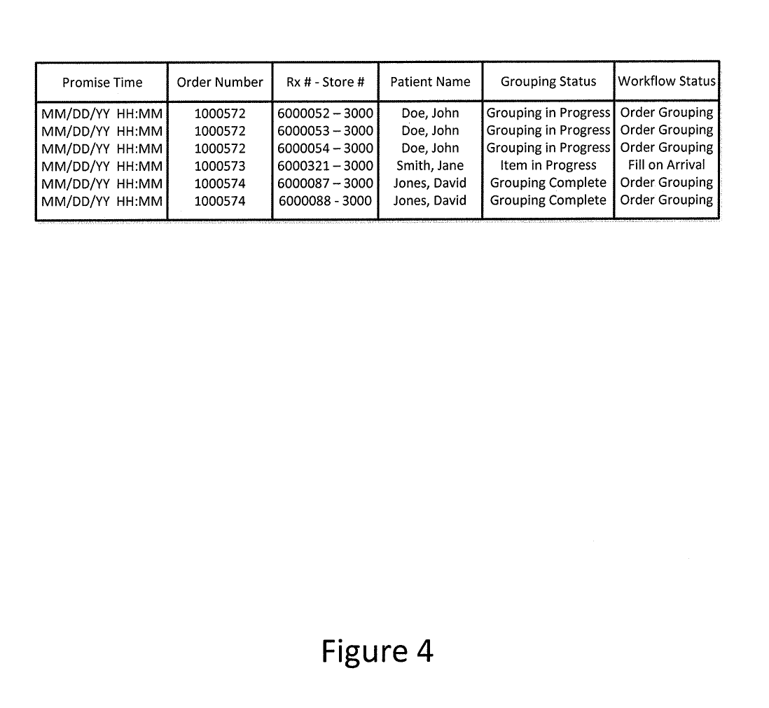

As shown in block 42 of FIG. 3, the computing device 20, such as the processing circuitry 22, e.g. the processor 24, may be configured to place the prescriptions in a grouping queue upon receipt of the prescriptions, such as in the order in which the prescriptions are received. The grouping queue may be maintained, for example, in memory 26 and, in some embodiments, a graphical user interface may be presented, such as by the user interface 30, e.g., the display, to depict the grouping queue, such as shown in FIG. 4. In an instance in which the first prescription is the initial prescription that is received, the first prescription may be placed in the grouping queue. Upon receipt of one or more subsequent prescriptions, each subsequent prescription may also be placed in the grouping queue and, as described below, may be evaluated to determine if the subsequent prescription should be grouped with any of the other prescriptions already in the grouping queue into a single order. Indeed, while an example embodiment is described in conjunction with the evaluation of first and second prescriptions that are received and placed in the grouping queue, any number of prescriptions may be received in any order in other embodiments.

By way of example in which at least a second prescription is received subsequent to receipt of the first prescription, the second prescription, as well as any other prescriptions, may also be placed into the grouping queue. As shown in block 44 of FIG. 3, the computing device 20, such as the processing circuitry 22, e.g., the processor 24, may be configured to determine whether the first prescription and any other prescriptions, including the second prescription, are received within a predefined window of time. See block 44. For example, the processing circuitry may associate a time of receipt with a respective prescription and/or a time at which a prescription is placed into the grouping queue with the respective prescription. Thus, in order to determine whether the first and second prescriptions have been received within a predefined window of time, the computing device, such as the processing circuitry, e.g., the processor, may be configured to determine if the first prescription has been in the grouping queue for no more than a predefined grouping time limit at the time of receipt of the second prescription. For example, if the first prescription has been in the grouping queue for no more than the predefined grouping time limit at the time that the second prescription is received, the first and second prescriptions may be considered to have been received within the predefined window of time. Alternatively, if the first prescription has been in the grouping queue for more than the predefined grouping time limit at the time that the second prescription is received, the first and second prescriptions may be considered not to have been received within the predefined window of time.

In an instance in which no other prescription is received within the predefined window of time of the first prescription, that is, the first prescription and the second and any other prescriptions are received at more widely spaced instances of time than permitted by the predefined grouping time limit, the first prescription may be individually fulfilled and, in an instance in which the first prescription is slated for mail order delivery, shipped on an individual basis. See block 48 of FIG. 3. Each of the other prescriptions may then be evaluated in the same manner in an effort to identify two or more prescriptions that are received within a predefined window of time and that may then be evaluated to determine if they are associated with the same patient as described below.

In an instance in which the first and second prescriptions and optionally one or more other prescriptions are received within the predefined window of time, the computing device 20, such as the processing circuitry 22, e.g., the processor 24, or the like, may be configured to determine whether the first and the other prescription(s), e.g., the second prescription, that were received within the predefined window of time are associated with the same patient. See block 46. This determination may be made in a variety of different manners. For example, a prescription that is received in the electronic or facsimile format may include information that identifies the patient identifier (ID) or the medical record number associated with the patient. Alternatively, the prescription may include information regarding the patient, such as the name of the patient, the address of the patient, the birthdate of the patient, etc. that may be utilized by the processing circuitry, such as the processor, in order to determine whether the first and second prescriptions are associated with the same patient. In an instance in which the processing circuitry, such as the processor, determines that the first prescription and the other prescription(s), e.g., the second prescription, are not associated with the same patient and are, instead, associated with different patients, the first prescription may be fulfilled and, in an instance in which the first prescription is slated for mail order delivery, may be shipped on an individual basis. See block 48 of FIG. 3.

However, if the first and one or more other prescriptions, e.g., the second prescription, is determined to have been received within the predefined window of time and have been associated with the same patient, the computing device 20, such as the processing circuitry 22, e.g., the processor 24, or the like, may be also configured to group the prescriptions, e.g., the first and second prescriptions, into a single order. See block 50 of FIG. 3. By being grouped into a single order, the computing device, such as the processing circuitry, e.g., the processor, may be configured to cause the prescriptions to be fulfilled on a collective basis. Additionally, in an instance in which the prescriptions are to be shipped, the prescriptions that are grouped into a single order may also be shipped together. By managing fulfillment and shipment of multiple prescriptions that have been grouped into a single order, the prescriptions may be processed in a more efficient manner. In this regard, the costs associated with manually grouping prescriptions may be reduced, if not eliminated, since the method, apparatus and computer program product of an example embodiment automatically group related prescriptions without manual intervention. Additionally, the costs associated with the separate shipment of prescriptions that are received close in time to one another and that relate to the same patient may be eliminated.

As described above, the grouping of prescriptions that are placed in a grouping queue within a window of time may be based upon the prescriptions being associated with the same patient. However, the grouping of prescriptions may also be contingent upon one or more other factors in accordance with other embodiments of the present invention. For example, the grouping of prescriptions that are placed in a grouping queue within a window of time may not only be contingent upon the prescriptions being associated with the same patient, but also upon the intake method, such as a computerized prescription submission application or facsimile, such that only prescriptions that were received via the same intake method are grouped together.

The predefined grouping time limit may be established in various manners and, in one embodiment is configurable by a user. In one embodiment, however, the predefined grouping time limit is established based upon the anticipated time delay that may reasonably occur between the receipt of multiple prescriptions from a physician for the same patient, such as in an instance in which a physician is writing several prescriptions for the same patient and transmits those prescriptions to the pharmacy, albeit with some delay between the transmission of individual prescriptions. In this instance, the multiple prescriptions for the same patient would preferably be grouped into a single order so as to facilitate efficient fulfillment and shipment. By way of example, but not of limitation, the predefined grouping time limit of one example embodiment may be five minutes. However, in other embodiments, the predefined grouping time limit may be shorter or longer depending upon the expected window of time during which prescriptions may be received for the same patient from the same physician.

Referring now to FIG. 4, an example of a grouping queue is depicted. As shown, the grouping queue may include a promised time at which the prescription is desired to be available for the patient, an order number, an identification of the prescription number and the pharmacy and/or store and the patient name. Additionally, the grouping queue may include a grouping status associated with each prescription. For some prescriptions that have been in the grouping queue for less than the predefined grouping time limit, the grouping status may be that grouping is in progress since incoming prescriptions will continue to be compared to these more recent prescriptions in order to determine if they should be grouped into a single order. Following the expiration of the predefined grouping time limit, such as in an instance in which a prescription has been in the grouping queue for more than the predefined grouping time limit, the grouping status may be that grouping is complete since no additional prescriptions that newly arrive into the grouping queue may be grouped with these older prescriptions. Indeed, once the predefined grouping time limit has expired, no prescriptions that newly arrive into the grouping queue may be grouped with the older prescriptions even though the older prescriptions may remain in the grouping queue to be further processed. In this regard, prescriptions or a group of prescriptions may be removed from the grouping queue either manually or automatically in order to permit the prescriptions to be filled and thereafter provided to the patient.

With respect to the example of FIG. 4, the three prescriptions for John Doe have been in the grouping queue for less than the predefined grouping time limit such that the grouping status is grouping in progress. However, since the three prescriptions for John Doe relate to the same patient and have been received within the predefined window of time, the workflow status is order grouping to indicate that multiple prescriptions have been or will be grouped into a single order and, as a result, have the same order number. Additionally, the two prescriptions from David Jones have been in the grouping queue for longer than the predefined grouping time limit such that the grouping is complete. Since the two prescriptions for David Jones relate to the same patient and were received within the predefined window of time, the two prescriptions for David Jones have also been grouped together into a single order as represented by the workflow status of order grouping. Although each new prescription that is placed into the grouping queue is compared to all of the other prescriptions within the grouping queue or at least all of the other prescriptions that have been in the grouping queue for less than the predefined grouping time limit, not all of the prescriptions are grouped. For example, the prescription for Jane Smith has not been grouped with any of the other prescriptions since none of the other prescriptions are for the same patient.

In an example embodiment, the predefined window of time is established by the oldest prescription in a group. Thus, the predefined window of time during which prescriptions that newly arrive at the grouping queue may be grouped with a prior prescription closes when the oldest prescription in the group has been in the grouping queue for the predefined grouping time limit. Consequently, some of the prescriptions in a group may have been in the grouping queue for less than the predefined grouping time limit at the time that other prescriptions newly arrive at the grouping queue. However, if the oldest prescription in the group has been in the grouping queue for at least the predefined grouping time limit, the group is closed and the newly arriving prescriptions cannot be added to the group, even though some of the other prescriptions in the group have been in the grouping queue for less than the predefined grouping time limit.

An order consisting of one or more prescriptions may include one or more order level parameters. A variety of order level parameters may be defined and associated with an order. For example, the order level parameters may include the delivery method, such as whether the prescription is to be picked up by the patient or mailed to the patient. If the prescription is to be shipped to the patient, the order level parameters may also include the shipping method. Other order level parameters include an indication as to whether the prescription is a high priority, the promised time by which the prescription should have been filled and be available to the patient and the method by which the patient is to pay for the prescription.

In an instance in which multiple prescriptions have been grouped into a single order, the computing device 20, such as the processing circuitry 22, e.g., the processor 24, or the like, may be configured to associate the same order level parameters with all prescriptions grouped into a single order. See block 52 of FIG. 3. The order level parameters that are associated with all prescriptions grouped into a single order may be defined in various manners. In one example embodiment, the first prescription, that is, the oldest prescription or, in other words, the first prescription of the order that was placed into the grouping queue may define the order level parameters for all other prescriptions that are grouped into the same order, regardless of whether the other prescriptions have different order level parameters. Alternatively, the order level parameters for multiple prescriptions grouped into a single order may be defined to be those order level parameters that are the most specific or exacting even though some of the order level parameters may be provided by one prescription and other order level parameters may be provided by a different prescription of the same order. Further, the order level parameters may be defined based upon the order level parameters established by a majority of the prescriptions of the same order.

In one embodiment, the computing device 20, such as the processing circuitry 22, e.g., the processor 24, or the like, may determine whether there has been a change in the order level parameters for any one of the prescriptions grouped into the single order. See block 54 of FIG. 3. In this regard, after the prescriptions have been grouped into a single order and the order level parameters have been defined for the single order, such as upon expiration of the predefined window of time, the computing device, such as the communication interface 28, the processing circuitry or the like, may be configured to receive an indication, such as from the physician, the pharmacist or the like, changing one or more of the order level parameters for one of the prescriptions within a single order. In this instance, the computing device, such as the processing circuitry, e.g., the processor, may be configured to modify the order level parameter for all prescriptions grouped into the single order in response to the change in the order level parameter for one of the prescriptions. See block 56 of FIG. 3. In this regard, the order level parameter for all prescriptions within the group may be modified to be the same as the order level parameter that was changed. Additionally, the computing device, such as the processing circuitry, may be configured to modify the order level parameter regardless of whether or not the prescription for which the order level parameter was changed was the prescription that initially defined the order level parameters.

As noted above, the prescriptions that are grouped into a single order may be fulfilled and shipped together so as to increase the efficiency of the prescription fulfillment process. However, one or more of the prescriptions that have been grouped into a single order may sometimes be released in order to be advanced at a faster rate through the workflow, such as to be available for pickup or delivery to the patient, on a different basis, such as more quickly, than the remainder of the prescriptions in the single order. For example, a patient may arrive at a pharmacy and may indicate that one of the prescriptions from among the plurality of prescriptions in the single order is more important than the others. In this instance, the pharmacist may release the prescription that is of most importance to the patient such that the released prescription may be filled and delivered to the patient with the remainder of the prescriptions remaining grouped into the single order for joint fulfillment and shipment. As such, the computing device 20, such as the processing circuitry 22, the communication interface 28 or the like, may be configured to determine whether there has been a request received to release one or more prescriptions that have been previously grouped into a single order. See block 58 of FIG. 3. In an instance in which a request to release one or more prescriptions that have been previously grouped into a single order has been received, the computing device, such as the processing circuitry, e.g., the processor 24, may be configured to release the one or more prescriptions so as to be advanced at a faster rate through the workflow at a faster rate or sooner relative to one or more other prescriptions that were also grouped into the single order. See block 60 of FIG. 3. Otherwise, the computing device, such as the processing circuitry, e.g., the processor, may be configured to cause the prescriptions that remain grouped into a single order to be fulfilled and shipped together. See block 62 of FIG. 3.

As described above, FIG. 3 illustrates a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 26 of a computing device 20 and executed by processing circuitry 22 in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowchart support combinations of means for performing the specified functions and combinations of steps for performing the specified functions. It will also be understood that one or more blocks of the flowchart, and combinations of blocks in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 22 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a plurality of prescriptions in an electronic or facsimile format including receiving a first prescription and thereafter receiving a second prescription;
determining if the first and second prescriptions are associated with a same patient;
determining if the first and second prescriptions are received within a predefined window of time; and
in an instance in which the first and second prescriptions are associated with the same patient and are received within the predefined window of time, grouping, with processing circuitry, the first and second prescriptions into a single order.

2. A method according to claim 1 further comprising placing the first prescription in a grouping queue following receipt, wherein determining if the first and second prescriptions are received within a predefined window of time comprises determining if the first prescription has been in the grouping queue for no more than a predefined grouping time limit.

3. A method according to claim 2 wherein grouping the first and second prescriptions into a single order comprises grouping the first and second prescriptions into a single order in an instance in which the first prescription has been in the grouping queue for no more than the predefined grouping time limit upon receipt of the second prescription.

4. A method according to claim 1 further comprising causing the first and second prescriptions that have been grouped into a single order to be shipped together.

5. A method according to claim 1 further comprising associating the same order level parameters with all prescriptions grouped into a single order.

6. A method according to claim 5 further comprising modifying an order level parameter for all prescriptions grouped into the single order in response to a change in the order level parameter for one of the prescriptions grouped into the single order.

7. A method according to claim 1 further comprising releasing one or more prescriptions that have previously been grouped into a single order such that the one or more prescriptions are advanced through a workflow at a faster rate relative to one or more other prescriptions that were also previously grouped into the single order.

8. A computing device comprising processing circuitry configured to:
receive a plurality of prescriptions in an electronic or facsimile format including receiving a first prescription and thereafter receiving a second prescription;
determine if the first and second prescriptions are associated with a same patient;
determine if the first and second prescriptions are received within a predefined window of time; and
in an instance in which the first and second prescriptions are associated with the same patient and are received within the predefined window of time, group the first and second prescriptions into a single order.

9. A computing device according to claim 8 wherein the processing circuitry is further configured to place the first prescription in a grouping queue following receipt, wherein the processing circuitry is configured to determine if the first and second prescriptions are received within a predefined window of time by determining if the first prescription has been in the grouping queue for no more than a predefined grouping time limit.

10. A computing device according to claim 9 wherein the processing circuitry is configured to group the first and second prescriptions into a single order by grouping the first and second prescriptions into a single order in an instance in which the first prescription has been in the grouping queue for no more than the predefined grouping time limit upon receipt of the second prescription.

11. A computing device according to claim 8 wherein the processing circuitry is further configured to cause the first and second prescriptions that have been grouped into a single order to be shipped together.

12. A computing device according to claim 8 wherein the processing circuitry is further configured to associate the same order level parameters with all prescriptions grouped into a single order.

13. A computing device according to claim 12 wherein the processing circuitry is further configured to modify an order level parameter for all prescriptions grouped into the single order in response to a change in the order level parameter for one of the prescriptions grouped into the single order.

14. A computing device according to claim 8 wherein the processing circuitry is further configured to release one or more prescriptions that have previously been grouped into a single order such that the one or more prescriptions are advanced at a faster rate through a workflow relative to one or more other prescriptions that were also previously grouped into the single order.

15. A computer program product comprising a non-transitory computer readable medium having program code stored thereon, the program code comprising program code instructions configured, upon execution, to:
receive a plurality of prescriptions in an electronic or facsimile format including receiving a first prescription and thereafter receiving a second prescription;
determine if the first and second prescriptions are associated with a same patient;
determine if the first and second prescriptions are received within a predefined window of time; and
in an instance in which the first and second prescriptions are associated with the same patient and are received within the predefined window of time, group the first and second prescriptions into a single order.

16. A computer program product according to claim 15 wherein the program code further comprises program code instructions configured to place the first prescription in a grouping queue following receipt, wherein the program code instructions configured to determine if the first and second prescriptions are received within a predefined window of time comprise program code instructions configured to determine if the first prescription has been in the grouping queue for no more than a predefined grouping time limit.

17. A computer program product according to claim 16 wherein the program code instructions configured to group the first and second prescriptions into a single order comprise program code instructions configured to group the first and second prescriptions into a single order in an instance in which the first prescription has been in the grouping queue for no more than the predefined grouping time limit upon receipt of the second prescription.

18. A computer program product according to claim 15 wherein the program code further comprises program code instructions configured to cause the first and second prescriptions that have been grouped into a single order to be shipped together.

19. A computer program product according to claim 15 wherein the program code further comprises program code instructions configured to associate the same order level parameters with all prescriptions grouped into a single order.

20. A computer program product according to claim 19 wherein the program code further comprises program code instructions configured to modify an order level parameter for all prescriptions grouped into the single order in response to a change in the order level parameter for one of the prescriptions grouped into the single order.
